(19) United States
(12) Patent Application Publication
(10) Pub. No.: US 2017/0261452 A1
(43) Pub. Date: Sep. 14, 2017

(54) Universal Sensor Interface

(71) Applicant: Reduce LLC, Colorado Springs, CO (US)

(72) Inventor: Donald Black, Puerto Aventuras (MX)

(21) Appl. No.: 15/458,739

(22) Filed: Mar. 14, 2017

Related U.S. Application Data
(60) Provisional application No. 62/389,969, filed on Mar. 14, 2016.

(51) Int. Cl. G01N 27/02

(52) U.S. Cl. CPC G01N 27/028; H04W 4/005

(57) ABSTRACT

This disclosure relates generally to a sensor interface, and more generally to a universal sensor interface capable of providing a common hardware approach to interfacing multiple sensors of the same, similar or different applications and electronic features.

This application claims benefit of priority from U.S. Provisional Application No. 62/389,969 filed Mar. 17, 2017.

### BACKGROUND

There is an increasing prevalence of wireless sensor networks of monitoring systems across various industries and applications including industrial, medical, environmental, IT, agricultural and medical. With this increase in demand and application, the need to install these sensor systems and networks to ensure high reliability and low maintenance and cost is significant. However, the design and implementation of such systems is complex given the variety of different electronic features that may exist across various sensors networked together.

Prior art sensor interfaces such as that proposed in the article titled “A Universal Intelligent System-on-Chip Based Sensor Interface” by Virgiolio Mattoli et al., published Aug. 17, 2010, attempt to address these issues affecting sensor networks. However, physical hardware requirements specific to each sensor described in the Mattoli sensor interface require cost and maintenance needs to remain relatively high. The Mattoli interface requires a microcontroller to be incorporated in each sensor module. Unique modules of various configurations, each containing its own microcontroller, that plug into a single control system is disclosed. The requirement for programmable logic specific and physical to each sensor ensures a high degree of system maintenance and cost and impedes its ability to serve as a flexible, universal interface to the system.

A sensor interface that overcomes the prior art and that can address cost, maintenance and performance needs while serving as a universal interface to one or more networks across the multiple sensors of a sensor system is disclosed. The universal sensor interface (USI) of the present invention provides a reliable, flexible and low cost approach to interfacing multiple sensors of the same, similar or different applications and electronic features. The USI incorporates circuitry that maximizes the performance potential of each sensor so that a high performance for sensitivity to contaminants is achieved. Having the programmable logic central to the interface and separate from the individual sensors allows for maximum flexibility of the system and performance of the individual sensors. The USI described herein enables real-time performance of the system that is not interrupted or compromised compared with configurations of the prior art.

### SUMMARY

An electronic circuit that is an interface to multiple sensors, that maintains performance of a network of sensors without substantially increasing cost is described. The invention incorporates a sensor network wherein a microcontroller is physically associated with the circuit but is not required for the sensor interface. Thus the electronic circuit comprises a universal interface to sensors where the performance of the sensors is not substantially affected, regardless of the current and voltage requirements and features the sensors.

### BRIEF DESCRIPTION OF DRAWINGS

FIG. 1 is a schematic of a circuit illustrative of an embodiment of the present invention.

FIG. 2 is a schematic of a circuit illustrative of a common form of prior art.

FIG. 3 is a schematic of a circuit illustrative of an alternative embodiment of the present invention.

FIG. 4 is a schematic of a circuit illustrative of an alternative embodiment of the present invention.

FIG. 5 is a block diagram to describe an application of the present invention.

### DETAILED DESCRIPTION

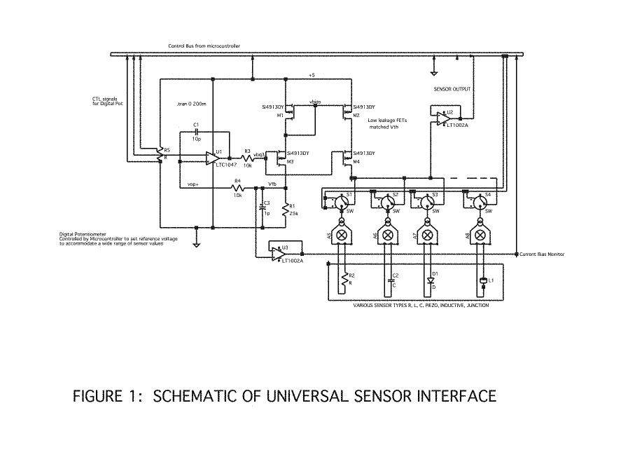

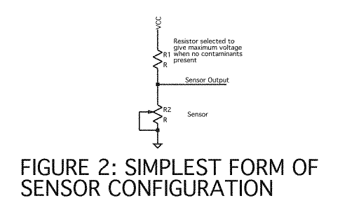

FIG. 1 is a circuit implementation representative of the Universal Sensor Interface (USI) of the present invention. FIGS. 2, 3, and 4 are some of the more common types of interface circuitry used for interfacing to a resistive sensor element. While there are other types of sensors and circuits associated with them, for purposes of description of the present invention, a focus on the resistive, semiconductor, or Chem-resistor type of sensor is presented. However, it will also be discussed how the USI of the present invention can connect to other types of sensors having different voltages and current requirements and features from each other. The USI described herein addresses the goal of serving as a universal sensor adaptor for interface to a family of circuit interfaces, i.e. that is plug and play with multiple types and/or classes of sensors. The USI accomplishes this in part through incorporation of a single microcontroller at the system interface. In a preferred embodiment, the USI can adapt to various different sensors and circuits regardless of their current, voltage or frequency requirements and features.

An initial description to the existing common circuitry and some of the characteristics is made. FIG. 2 shows the simplest form of interfacing to a resistive sensor. This circuit consists of a sensor and a bias resistor. The voltage monitored at the junction between the bias resistor and the sensor gives an indication of the presence and level of concentration of the contaminant to be monitored. A challenge with this type of interface is that while it will give an indication of presence of contaminants, the ability to quantify the concentration is limited; only that a lower voltage indicates a higher concentration, and thus its practical utility is low. Further, for optimum performance, the bias resistor must be selected to give a maximum voltage output when no contaminants are present, assuming the sensor responds to a contaminant by changing the resistor value downward. Since there is a variation in “clear air” resistance of the sensor, the bias resistor must be chosen for each individual sensor. In one embodiment of the prior art, the bias resistor could be a potentiometer that requires adjustment for each sensor.

This circuitry is adequate for gross measurements or a “GO-NO GO” measurement of a contaminant. Certainly, this is the lowest cost solution for these types of applications, however its application is limited.

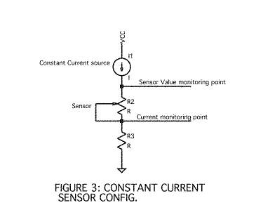

The circuit in FIG. 3 is an improvement over the simple bias resistor in that a constant current is supplied to the sensor and the current level is monitored by measuring the voltage across R3. The current source could be adjusted to provide the same current through the entire family of sensors, thus giving a more consistent response to contaminants as opposed to just being a voltage divider circuit as shown in FIG. 2. This implementation is adequate if the sensor resistance is low which will allow for higher currents to flow through the sensor and sense resistor, in that the sense resistor can be a small value thus not materially affecting the circuit. Problems develop when the resistance value of the sensor is high. In this case, the circuit design and layout of the PC boards is very tedious. For example, suppose there is a resistance value for the sensor of 1 Meg Ohm in an uncontaminated environment. If the system has a supply voltage of 5.0 volts, for a full scale reading of 5 volts across a 1 Meg resistor would require a current of 5 micro amps. At this current level, to detect a 100 mV level would require a 20K resistor. At the sensor value of 1 Meg, this value is not significant, but when contaminants are introduced and the sensor resistor value drops to, for example 50 kOhm, then the 20 kOhm resistor contributes substantially to the total measured voltage at the current source-sensor junction. Dropping the voltage across the sense resistor which amounts to reducing the sense resistor value, helps somewhat, but the additional care in circuit design and layout of the PC board becomes much more complex.

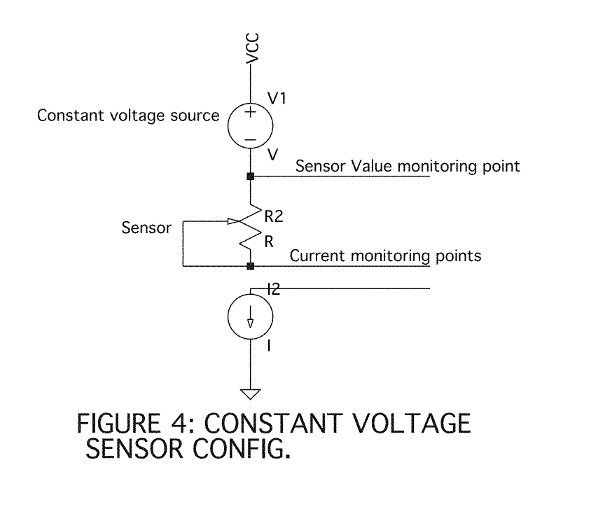

FIG. 4 illustrates a circuit that eliminates having the high value sense resistor in the circuit by essentially monitoring the current that flows through the sensor. As contaminant concentrate increases, the current will increase due to falling sensor resistance value. The circuit design is a bit more complicated for this example, however this type of circuit is better adapted for sensing contaminant at more precise levels than the examples provided in FIGS. 2 and 3, because the current source can be precisely adjusted to match the particular sensor's characteristics. Moreover, this configuration lends itself to provide an automatic calibration for individual sensors of the same type but with slightly different values at specific contamination levels. This is especially useful in systems utilizing a set trip point to provide an alarm rather than providing high precision readings of contaminant levels.

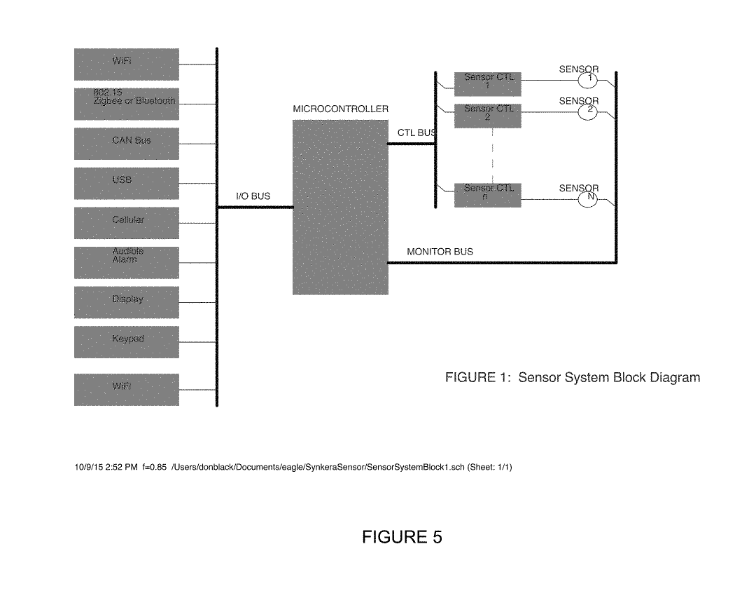

FIG. 5 is a block diagram of the complete system of the USI of the present invention wherein the preferred embodiment is designated as Sensor CTL. The maximum number of these Sensor CTL blocks is limited by the available input/output ports of the microcontroller. Each Sensor CTL block contains the circuitry as shown in FIG. 1, and depending upon the class of sensor, there will be additional timing and control circuitry to optimize the performance. As shown in FIG. 5, all the sensors are controlled by the microcontroller, likewise, sensor values are monitored by the microcontroller. To provide communication with useful data, the microcontroller can interface to any number of communications products/protocols as well as serve as a client to publish information to the web or to the administrator of the network. A discussion of the various communications protocols and methodologies is beyond the scope of the present disclosure.

Referring back to the implementation depicted in FIG. 1, for simplicity sake, the heater element circuitry is not shown and is well known to those skilled in the art. FIG. 1 is essentially a constant current method of driving and monitoring the sensor. The main difference between this circuit and the others discussed is that monitoring of the current or voltage does not impact the performance of the sensor. This is accomplished by using a current mirror wherein the constant current is set up and monitored by setting the value of either the sense resistor (R1) or changing the reference voltage by modifying the digital potentiometer value of R5. In actual implementation, R5 will be changed to modify the reference voltage, resulting in a change of constant current supplied to the sensor. This process step can be either accomplished manually, or in a preferred embodiment, is easily automated and will be part of the auto-calibration technique to be used in the system. Another advantageous feature of this embodiment of the present invention is that the sensor values are not restricted, and can vary between sensors.

Use of a current mirror is known in the prior art, conceived by Bob Widlar in the late 1960s. The advantageous incorporation of the mirror in the USI enables undesired effects to be avoided in the monitoring circuit by not having any extraneous circuitry in the sensor leg.

As a brief explanation of the current mirror, the mirror consists of transistors M1, M2, M3, and M4 along with resistor R1. Transistors M1 and M2 are connected in such a manner that the Gate to Source voltage of M1 is exactly the same as the Gate to Source voltage of M2. Without deriving the equations for a MOSFET, their operation is:

Ids1=B*((Vgs1−Vt1)̂2)/2 and Ids2=B*((Vgs2−Vt2)̂2)/2

In a preferred embodiment of the invention the transistors are on the same silicon substrate. This means that Vt1=Vt2 and B is the same for at least M1 and M2. Due to the connection of the Gate to Drain of M1, that means that Vgs1=Vgs2 and consequently, Ids1 will equal Ids2. Furthermore, having the devices on the same substrate will ensure all devices are at the same temperature, eliminating any adverse affects due to variation of device temperatures.

The operation of the USI is as follows. As previously mentioned, the current through R1 will be reflected to the current through R2. This current is monitored and controlled by reading the voltage across R1 and comparing it to a reference voltage set up by R5. In this manner, current can be dynamically selected by changing the value of the reference voltage set up by R5.

Transistor M3 regulates the current through R1 to keep it constant. Transistor M4 is placed in the circuit to provide matching voltage drops and current leakage in both legs of the circuit.

Although a discreet current mirror implementation is described above, there are many commercially available voltage controlled current sources available as an integrated circuit that will serve the same or similar purpose.

As illustrated on FIG. 5, the Universal Sensor Interface is monitored and controlled by a sole microcontroller incorporated within the USI circuitry, avoiding the need for this type of functionality associated with each individual sensor. With the power of today's microcontrollers, all the necessary A to D and D to A conversions are accomplished within the microcontroller. Additionally, Auto-calibration and regular health monitoring of the sensor can be accomplished by the microcontroller as well as curve fitting the response of a particular sensor to a particular contaminant. The single microcontroller interfaces to analog and digital circuitry that will interface to a large family of sensors and sensor types with the only modifications needed during maintenance or operation being a change in microcontroller firmware which can be accomplished by wireless means.

Although this discussion focuses on the chem-resistor or resistive element sensor, the USI circuitry described herein can be used to interface to a capacitive sensor, a piezoelectric type of transducer, MOSFET and diode type sensors with little changes to the circuitry. For example, to interface to a capacitive sensor, the identical current sources and mirrors can be used to charge and discharge a capacitive sensor and rather than measure the voltage across a resistive sensor, the time required to charge a capacitive sensor can be measured, and a change in the capacitive sensor's value will reflect as a change in time required to discharge or charge the capacitor with a constant current source.

The same circuitry can be used in a bridge type sensor configuration to bias the bridge. An additional amplifier stage (not shown in the schematics) will interface directly to the sensor to give a differential reading of the bridge. FIG. 1 depicts a circuitry configuration where any class of sensor can be included on the circuit board and this sensor with its associated conditioning circuitry can be digitally selected by the microcontroller. This is accomplished by enabling one of the switches S1 to S4. The system is not limited to four switches, and could include many more, limited by the address capability of the microcontroller.

Each sensor is connected to signal conditioning circuitry A5 to A8. Likewise, the limitation of the number of conditioning circuits is determined by the address capability of the microcontroller.

The signal conditioning circuitry is determined by the characteristics of a particular sensor type. For example, the capacitive sensor is typically controlled by charging and discharging of the sensor and measuring the rise time, fall time, or a frequency of oscillation determined by the capacitance of the sensor. A change in capacitance results in a change of the above mentioned parameters. Likewise, each sensor type will have some signal conditioning associated with the sensor which will send to the microcontroller a voltage level (resistive sensor), frequency, pulse width, rise or fall time. For example, a voltage controlled switch could be placed across a capacitive type sensor to provide a discharge path for the capacitor and then the capactive sensor would be charged up via the current source. Through measuring the time to charge and knowing the charging current value, the value of the capacitor could be computed.

It is contemplated in another embodiment of the invention, that the USI interfaces to a specific set of circuitry common to one or more classes of sensor (resistive, capacitive, or other), and another type of circuitry interfaces to another class of sensor (inductive, etc.). In such embodiment, the universal sensor interface will interface to nearly any of multiple sensors of various electrical features within that class. In this alternative embodiment, the interface circuitry of the USI specific to that class of sensor will interface to nearly all sensors of that type, because the microcontroller and interface are automatically adjusted to allow for a broad range of sensor parameters.

What is claimed is:

1. An electronic circuit that is an interface to multiple sensors, wherein a microcontroller is physically associated with the circuit and the performance of the sensors is not substantially affected.

2. The electronic circuit of claim 1, wherein one or more of the sensors have different current requirements of another of the sensors.

3. The electronic circuit of claim 1, wherein one or more of the sensors have different voltage requirements of another of the sensors.

4. The electronic circuit of claim 1, wherein the circuit has programmable logic.

5. The electronic circuit of claim 1, wherein transistors of the circuit are on a same silicon substrate.
